(19) United States
(12) Patent Application Publication
(10) Pub. No.: US 2014/0106607 A1
(43) Pub. Date: Apr. 17, 2014

(54) ELECTRICAL CONNECTION BOX

(71) Applicant: Sumitomo Wiring Systems, Ltd., Yokkaichi-City (JP)

(72) Inventor: Ryo Suenaga, Yokkaichi-City (JP)

(73) Assignee: Sumitomo Wiring Systems, Ltd., Yokkaichi-City (JP)

(21) Appl. No.: 14/047,063

(22) Filed: Oct. 7, 2013

(30) Foreign Application Priority Data
Oct. 17, 2012 (JP) 2012-229979

(51) Int. Cl. H01R 13/73

(52) U.S. Cl. CPC H01R 13/73
USPC 439/527

(57) ABSTRACT

An electrical connection box includes a bracket insertion member having an insertion hole for receiving an insertion plate of a fixing bracket on an automobile. The insertion hole includes edge insertion holes into which edges of the insertion plate of the fixing bracket are inserted. Additionally, a guide surface is formed on an opening of each edge insertion hole such that the guide surface extends obliquely out from the opining in directions opposite to the direction of insertion of the insertion plate into the insertion hole. Each guide surface extends out in the direction along which the edge insertion holes oppose each other and in directions orthogonal to the direction along which the edge insertion holes oppose each other. The dimension W between the outer edge of each opening and the outer edge of the respective guide surface is no less than the thickness t of the insertion plate.

### BACKGROUND OF THE INVENTION

1. Field of the Invention

The invention relates to an electrical connection box with a bracket insertion member into which a fixing bracket provided on an automobile is inserted.

2. Description of the Related Art

Conventionally, the wiring components of an automobile include a variety of electrical connection boxes in suitable locations for housing concentrated electrical connection, such as relay holders, connector holders, fuse boxes, and junction boxes, and efficiently supplying power to the various electrical components of the automobile. These electrical connection boxes are secured to the suitable locations in the automobile via fixing brackets provided on the automobile.

JP 2009-195085A discloses a structure commonly used in an electrical connection box to secure the connection box to a fixing bracket. More particularly, an insertion plate is formed at the forward end of a fixing bracket and is inserted into an insertion hole of a bracket insertion member provided on the electrical connection box. The bracket insertion member clamps the insertion plate in the insertion hole to mount the electrical connection box securely on the fixing bracket.

The opening of the insertion hole of the bracket insertion member has approximately the same width as the thickness of the insertion plate of the fixing bracket. Therefore, an operator needs to align the insertion plate of the fixing bracket accurately with the opening of the insertion hole of the bracket insertion member to insert the fixing bracket into the bracket insertion member. This requires highly accurate parts positioning by the operator, resulting in lower work efficiency.

In particular, when the direction with respect to the bracket insertion member in which the fixing bracket is inserted is oblique or horizontal rather than vertical, visual confirmation of accurate alignment between the opening of the insertion hole and the insertion plate of the fixing bracket becomes more difficult, which may further affect the work efficiency. Accordingly, a need has long been felt for effective measures against this problem to improve the work efficiency.

The invention has been made in the light of the above-described problem and an object of the invention is to provide an electrical connection box having a bracket insertion member that permits easy insertion of a fixing bracket.

### SUMMARY OF THE INVENTION

The invention relates to an electrical connection box comprising a bracket insertion member having an insertion hole into which an insertion plate of a fixing bracket on an automobile is inserted. The insertion hole has edge insertion holes for receiving edges of the insertion plate of the fixing bracket. A guide surface is formed on an opening of each edge insertion hole. The guide surface extends obliquely out from the opening in directions opposite to the inserting direction of the insertion plate into the insertion hole. Each guide surface extends out in the direction along which the edge insertion holes oppose each other and in directions orthogonal to the direction along which the edge insertion holes oppose each other. In a planar view of the bracket insertion member, the dimension between an outer edge of each opening and an outer edge of the associated guide surface is no less than the thickness of the insertion plate. Thus, each guide surface has a relatively large area that surrounds a large part of the periphery of the edge insertion hole. The insertion plate may be misaligned in the width direction when inserting the insertion plate of the fixing bracket into the insertion hole of the bracket insertion member. However, the misaligned insertion plate contacts the guide surfaces and is guided toward the edge insertion holes in the width direction of the plate to bring the insertion plate to its intended position. The insertion plate also may be misaligned in the direction of thickness of the plate. However, the misaligned insertion plate contacts the guide surfaces that extend in the up and down directions and is guided toward the edge insertion holes in the thickness direction of the plate so as to bring the insertion plate to its intended position.

The guide surfaces are configured to provide sufficient areas of contact with the insertion plate around relatively large ranges of the peripheries of the respective edge insertion holes. More particularly, in a planar view, the dimension between the outer edge of the opening of each edge insertion hole and the outer edge of the associated guide surface is at least the same as the thickness of the insertion plate. Accordingly, an operator need not rely on visual observation to accurately align the insertion plate of the fixing bracket with the insertion hole of the bracket insertion member. Rather, the operator merely has to bring the edge insertion holes of the bracket insertion member toward the general location of the insertion plate of the fixing bracket. This simple procedure securely guides the insertion plate to the insertion hole of the bracket insertion member.

The foregoing feature of the invention facilitates mounting the electrical connection box to the fixing bracket with excellent work efficiency and without affecting the ease of assembly of the parts even when the bracket insertion member of the electrical connection box needs to be inserted horizontally or any other orientation that makes visual confirmation of accurate alignment more difficult. The dimension between the outer edge of the opening of each edge insertion hole and the outer edge of the associated guide surface in a planar view of the bracket insertion member preferably is at least 1.5 times, and more preferably twice or more the thickness of the insertion plate for the guide surfaces to effectively guide the insertion plate.

Additionally, by simply forming the above-described guide surface only around each edge insertion hole, the entire insertion plate can be effectively and advantageously guided to its proper position. This saves space and enhances the design freedom without the need to provide a guide surface at the central area of the insertion hole.

Each guide surface preferably extends in a generally conical shape around the opening of the associated edge insertion hole. However, other configurations will suffice for the guide surfaces provided that they have a tapered shape extending obliquely out from the openings of the edge insertion holes. For example, each guide surface may include numerous tapered surfaces connected circumferentially via inflections. Preferably, however, each guide surface is configured in an approximate conical shape expanding around the associated opening. Therefore, the insertion plate of the fixing bracket and the guide surfaces of the bracket insertion member will not get caught on each other, thereby allowing smoother guiding of the insertion plate into the edge insertion holes.

A finger-engaging portion preferably is formed on a rear side of each guide surface along outer peripheries of the bracket insertion member. The finger-engaging portion widens towards the opening of the edge insertion hole from an intermediate point along the depth of the edge insertion hole. Thus, the operator can use the rear sides of the guide surfaces as finger-engaging portions to stably and securely carry out the insertion of the insertion plate of the fixing bracket horizontally into the edge insertion holes of the bracket insertion member while taking advantage of the guiding ability of the guide surfaces. Therefore, this aspect of the invention advantageously facilitates proper parts alignment and stabilizes insertion work with a small number of parts.

The inclination of each guide surface with respect to a central axis of the edge insertion hole preferably is between 30 degrees and 60 degrees. The 30-60 degree inclination of each guide surface to a central axis of the edge insertion hole brings about a combination of the excellent guiding and space-saving abilities of the guide surface. In particular, a guide surface inclined at less than 30 degrees is not likely to have sufficient space in directions orthogonal to the direction of the insertion of the insertion plate. For this reason, too steep an inclination diminishes the effect of enlarging the area of the openings of the edge insertion holes by the guide surface. On the other hand, guide surfaces inclined at more than 60 degrees may cause slide friction between the edge insertion plate and the guide surfaces to increase to the point where the operator experiences excessive resistance to the plate insertion.

The electrical connection box of the invention includes guide surfaces inclined towards the respective openings with each guide surface having a relatively large area that surrounds a large part of the periphery of the associated edge of the insertion hole of the bracket insertion member. Accordingly, an operator need not visually confirm accurate alignment between the insertion plate of the fixing bracket and the insertion hole of the bracket insertion member. Rather, a simple procedure of bringing the insertion hole close to the insertion plate of the fixing bracket allows the operator to guide the insertion plate to the insertion hole.

### BRIEF DESCRIPTION OF THE DRAWINGS

FIG. 1 is a front elevation of an electrical connection box according to an embodiment of the invention, showing the electrical connection box mounted on the automobile.

FIG. 2 is a perspective view of the electrical connection box according to one embodiment of the present invention.

FIG. 3 is a front elevation of the electrical connection box shown in FIG. 2.

FIG. 4 is a vertical cross section taken along line IV-IV of FIG. 3.

FIG. 5 is a vertical cross section taken along line V-V of FIG. 3.

### DETAILED DESCRIPTION OF THE PREFERRED EMBODIMENTS

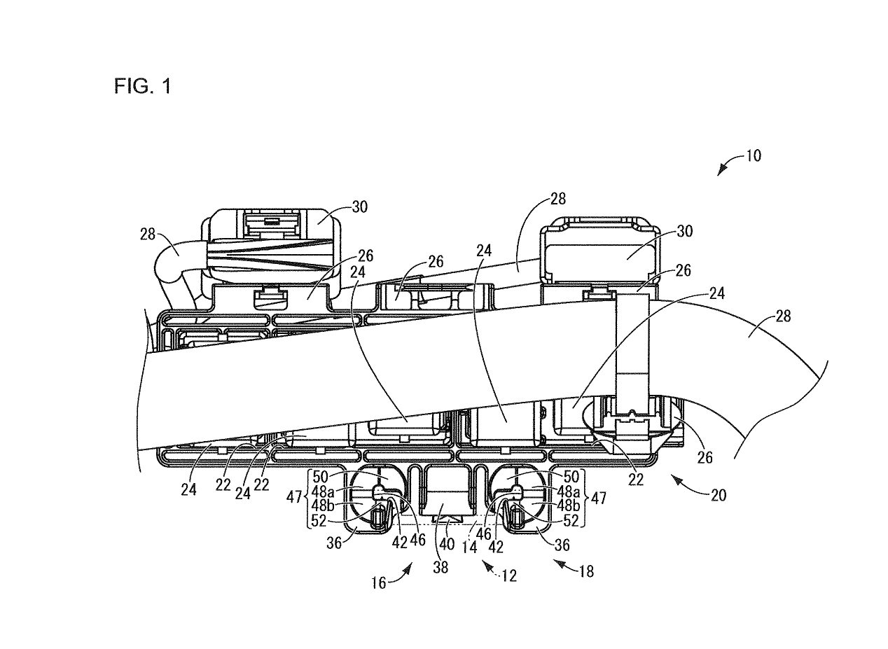

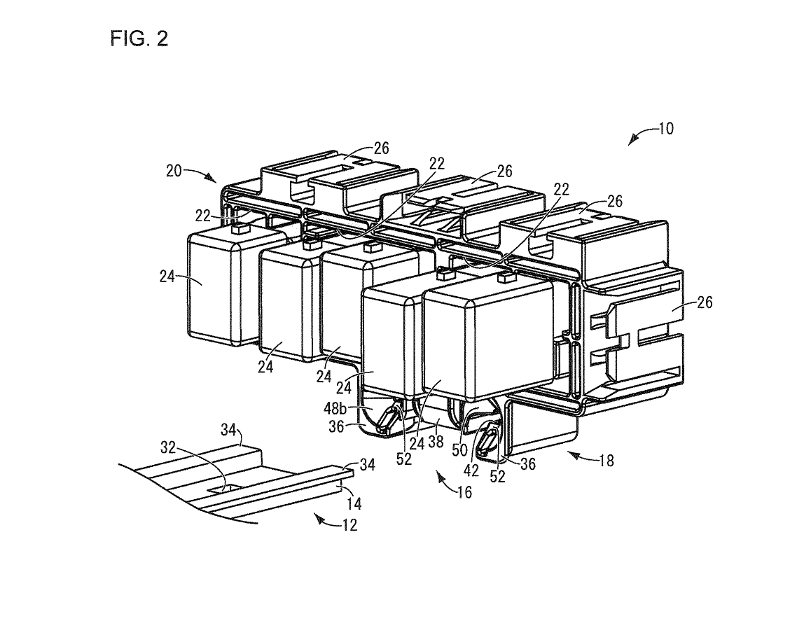

FIGS. 1-5 show a relay holder 10 in accordance with the invention. As shown in FIGS. 1 and 2, the relay holder 10 comprises a bracket insertion member 18 including an insertion hole 16 into which the insertion plate 14 of a fixing bracket 12 provided on an automobile is inserted. As used in the description of the embodiment below, the upward and downward directions refer to the vertical directions as seen in FIG. 1. The direction in which the fixing bracket 12 is inserted into the bracket insertion member 18 of the relay holder 10 is referred to as the horizontal direction. Additionally, the terms “forward” and “rearward” refer to the directions to the left and right, respectively, of referenced objects as seen in FIG. 2.

As shown in FIGS. 1 and 2, the relay holder 10 includes a case 20 that has a generally rectangular frame structure. Relay mounts 22 are provided at one opening on the front side of the case 20 and seat a plurality of relays 24. Connector mounts 26 are provided on the upper and side surfaces of the surrounding walls of the case 20. Connectors 30 are mounted on the connector mounts 26 and are assembled to wire harnesses 28 for electrical conduction with the relays 24. The bracket insertion member 18 is provided on the under surface of the surrounding wall of the case 20. The relay holder 10 is formed integrally or unitarily of polypropylene (PP), polyamide (PA), or other suitable synthetic resin, for example, by injection molding.

FIG. 2 shows the insertion plate 14 of the fixing bracket 12 to be inserted into the insertion hole 16 of the bracket insertion member 18. For clarity of viewing, the wire harnesses 28 and the connectors 30, to which the wire harnesses 28 are assembled, are omitted from FIGS. 2-5. As shown in FIG. 2, the insertion plate 14 of the fixing bracket 12 has a cross section in the shape of an upside-down hat. The insertion plate 14 has its center portion bent to form a groove and a pair of flange-like edges 34 extending from the groove. Additionally, the insertion plate 14 includes a rectangular lock hole 32 formed in the center portion.

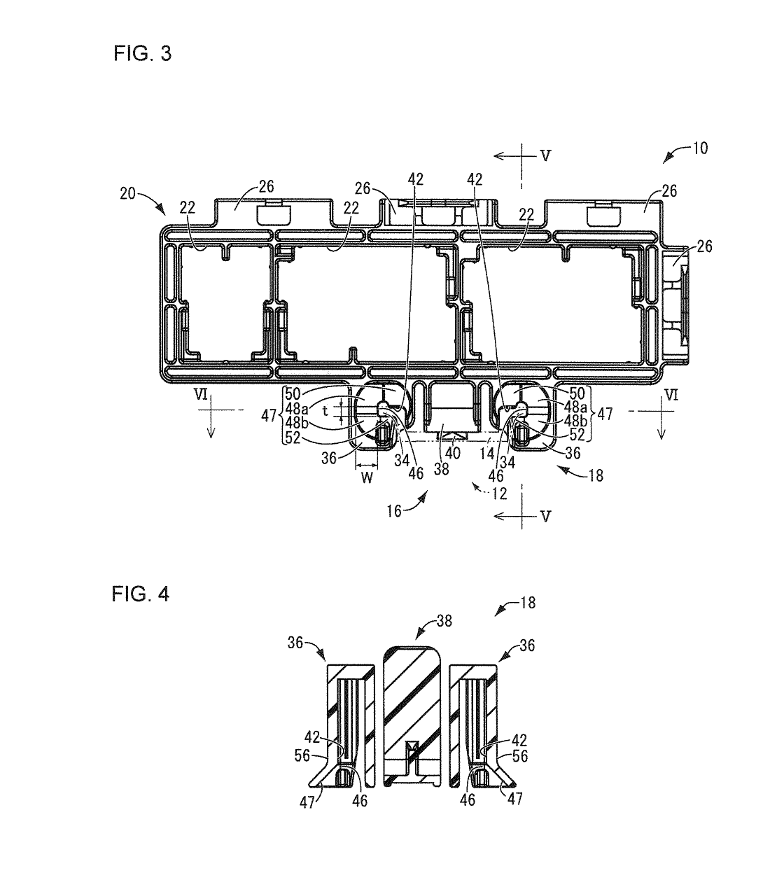

The bracket insertion member 18 of the relay holder 10 comprises two edge holders 36 each having an approximate shape of a rectangular block for holding the edges 34 of the insertion plate 14. The bracket insertion member 18 also comprises a ridge 38 in an approximate shape of a rectangular block formed between the edge holders 36 so as to fit into the groove-shaped center portion of the insertion plate 14. The ridge 38 has an approximately rectangular cross section extending in the direction in which the insertion plate 14 is inserted. A lock lug 40 is provided on the under surface of the ridge 38 in a manner that allows the lock lug 40 to flex or deform. Likewise, the two edge holders 36 have an approximately rectangular cross section extending in the direction in which the insertion plate 14 is inserted. Two edge insertion holes 42 are formed inside the holders 36 and receive the respective edge portions 34 of the insertion plate 14 are inserted. The edge insertion holes 42 extend in the direction of the insertion of the insertion plate 14. As shown in the planar views of FIGS. 1 and 3, each of the edge insertion holes 42 has an inverted L-shaped cross section that corresponds to the respective edge portion 34 of the insertion plate 14. One end of each edge insertion hole 42 extends close to the bottom wall of the respective edge holder 36 (the upper portion of FIG. 4) and the other end opens at the upper surface of the edge holder 36 (the lower portion of FIG. 4).

To insert the insertion plate 14 of the fixing bracket 12 into the bracket insertion member 18, first, the edge portions 34 of the insertion plate 14 are pushed into the edge insertion holes 42 of the bracket insertion member 18. Concurrently, the ridge 38 of the bracket insertion member 18 is fit into the groove-shaped center portion of the insertion plate 14. Subsequently, the insertion plate 14 is pushed farther into the bracket insertion member 18 while flexing the lock lug 40 provided on the under surface of the ridge 38. Upon reaching the lock hole 32 of the insertion plate 14, the lock lug 40 returns to its original shape and fits into and engages the lock hole 32, thus detachably securing the insertion plate 14 of the fixing bracket 12 to the bracket insertion member 18. As clear from the foregoing description, the insertion hole 16 of the bracket insertion member 18 includes the edge insertion holes 42 and the space defined below the under surface of the ridge 38.

Furthermore, as shown in FIGS. 1 and 3, the edge insertion holes 42 of the bracket insertion member 18 of the relay holder 10 define openings 46 and guide surfaces 47 surround nearly the entire circumferences of the openings 46. The guide surfaces 47 extend obliquely out in directions opposite to the direction in which the insertion plate 14 is inserted into the insertion hole 16. More particularly, each guide surface 47 comprises a first partial guide surface 48 which in turn includes first split guide surfaces 48a and 48b extending in a horizontally outward direction (to the right and the left in FIGS. 1 and 3) along which the edge insertion holes 42 oppose each other (“the opposing direction”) as well as in the vertically up and down directions orthogonal to the opposing direction. Each guide surface 47 also comprises a second split guide surface 50 and a third split guide surface 52 extending in along the opposing direction of the edge insertion holes 42 and in the vertically up and down directions orthogonal to the opposing direction.

Each of the first split guide surfaces 48a and 48b defines a quarter conical surface that extends over an approximately 90-degree range. Therefore, the two first split guide surfaces 48a and 48b, in combination, form a half conical surface extending over an approximately 180-degree range in an outward direction along which the edge insertion holes 42 oppose each other as well as the vertically up and down directions orthogonal to the opposing direction of the insertion holes. As shown in the planar view of the bracket insertion member 18 of FIG. 3 the dimension W between the outer edge of the opening 46 of each edge insertion hole 42 and the outer edge of the first partial guide surface 48 is approximately twice the thickness t of the insertion plate 14.

Each second split guide surface 50 defines a quarter conical surface that extends over an approximately 90-degree range. The second split guide surface 50 also extends inward in the direction along which the edge insertion holes 42 oppose each other (“the opposing direction”) and in the vertically upward direction orthogonal to the opposing direction. Each of the third split guide surface 52 defines a partially conical surface that extends across/over an approximately 30-degree range. The third split guide surface 52 also extends inwardly in the direction along which the edge insertion holes 42 oppose each other (“the opposing direction”) and in the vertically downward direction orthogonal to the opposing direction. In combination, each set of the first, second, and third split guide surfaces 48a, 48b, 50, and 52 constitutes a guide surface 47 extending in a generally conical shape around the opening 46 of an edge insertion hole 42.

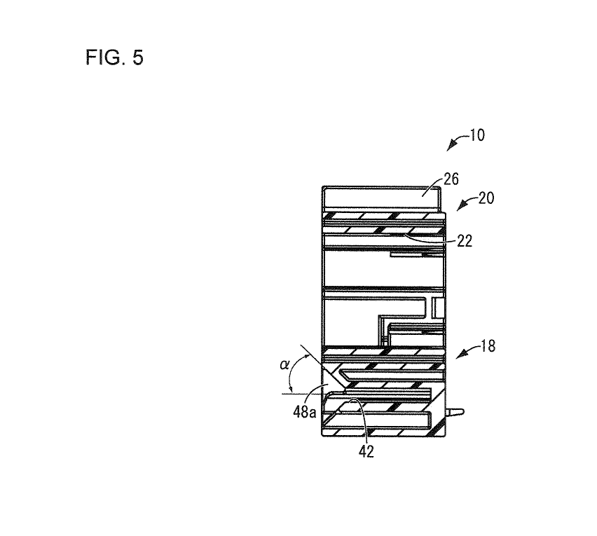

A finger-engaging portion 56 is formed on the rear side of each guide surface 47 along the outer periphery of the bracket insertion member 18, as shown in FIG. 4. The finger-engaging portion 56 also widens towards the guide surface 47 beyond the opening 46 from an intermediate point along the depth of the edge insertion hole 42. Turning now to FIG. 5, the inclination a of each guide surface 47 relative to the central axis of the respective edge insertion hole 42 is approximately to 40 degrees.

As shown in FIGS. 1 and 2, the relay holder 10 may have to be inserted into the insertion plate 14 of the fixing bracket 12 in a horizontal direction. The wire harnesses 28, the relays 24, or other parts tend to block the line of sight of the operator during such horizontal insertion, thereby making it difficult to visually observe the area of insertion between the hole 16 and the plate 14. Under these circumstances, it could be extremely difficult to insert the edge portions 34 of the insertion plate 14 of the fixing bracket 12 into the edge insertion holes 42 of the bracket insertion member 18 of the relay holder 10.

The relay holder 10, however, includes the guide surfaces 47, which are conically inclined towards their respective openings 46 of the bracket insertion member 18 to surround the large areas around the edge insertion holes 42. When inserting the insertion plate 14 of the fixing bracket 12 into the insertion hole 16 of the bracket insertion member 18, the insertion plate 14 may be out of alignment with the insertion hole 16 in the width direction of the insertion plate 14. In this case, the edges 34 of the insertion plate 14 contact the first split guide surfaces 48a, 48b and are guided toward the edge insertion holes 42 so as to bring the insertion plate 14 to its desired position. Similarly, the insertion plate 14 may also be misaligned with the insertion hole 16 in the direction of the thickness of the insertion plate 14. In this case, the edges 34 of the insertion plate 14 contact the first split guide surfaces 48a, 48b, the second split guide surfaces 50, or the third split guide surfaces 52, and are guided toward the edge insertion holes 42 to bring the insertion plate 14 to its desired position. In other words, even when visual confirmation of accurate alignment between the insertion plate 14 and the insertion hole 16 is extremely difficult, the operator merely has to bring the insertion hole 16 of the bracket insertion member 18 to the general location of the insertion plate 14 of the fixing bracket 12. This simple procedure securely guides the insertion plate 14 to its proper position in the insertion hole 16 of the bracket insertion member 18.

The guide surfaces 47 are configured so that the dimension W between the outer edge of the opening 46 of each edge insertion hole 42 and the outer edge of the associated guide surface 47 is approximately twice the thickness t of the insertion plate 14. In a conventional electrical connection box, the insertion hole defines an opening that has only approximately the same width as the thickness t of the insertion plate 14. In this embodiment, however, the guide surfaces 47 enlarge the openings 46 of the edge insertion holes 42 vertically and laterally by approximately twice the thickness of the insertion plate 14. This is equivalent to the openings 46 of the edge insertion holes 42 having a width approximately five times the thickness t of the insertion plate 14. In this way, the guide surfaces 47 extend over far larger areas around the openings 46 of the edge insertion holes 42 than the conventional counterparts, and the operator can easily guide the insertion plate 14 into the insertion hole 16 of the bracket insertion member 18 without relying on visual observation for accurate parts alignment. It should be understood that the openings of the edge insertion holes 42 can be sufficiently and effectively widened by the guide surfaces 47 if the dimension W between the outer edge of each opening 46 and the outer edge of the associated guide surface 47 is no less than the thickness t of the insertion hole 14. Preferably, the dimension W should be at least 1.5 times larger, and more preferably, at least twice larger than the thickness t as in this embodiment.

By simply forming guide surfaces 47 around the edge insertion holes 42 of the insertion hole 16, the entire insertion plate 14 can be guided effectively and advantageously to its proper position. For this reason, compared with the case where the guide surfaces 47 are provided in all regions of the insertion hole 16, the relay holder 10 of this embodiment facilitates mounting the bracket insertion member 18 to the fixing bracket 12 while saving space and enhancing the degree of design freedom.

Each set of the first, second, and third split guide surfaces 48a, 48b, 50, and 52, in combination, constitutes a guide surface 47 extending in a generally conical shape around the opening 46 of an edge insertion hole 42. When the insertion plate 14 of the fixing bracket 12 is brought into contact with the guide surfaces 47 of the bracket insertion member 18, this configuration prevents these members from being caught on each other, thus providing smoother guiding of the insertion plate 14 into the insertion hole 16.

Finger-engaging portions 56 are formed on the outer peripheries of the bracket insertion member 18, widening towards the openings 46 of the edge insertion holes 42 from an intermediate point along the depth of the edge insertion holes 42. When inserting the insertion plate 14 of the fixing bracket 12 horizontally into the insertion hole 16, the operator can use the finger-engaging portions 56 to stably carry out the insertion.

Referring now to FIG. 5, the inclination a of each of the first partial guide surfaces 48 with respect to the central axis of the edge insertion hole 42 is set to approximately 40 degrees. This provides for both the excellent guiding ability of the guide surfaces 47 and efficient use of space. In particular, if the inclination of the guide surfaces 47 is less than 30 degrees, it becomes difficult to provide the guide surfaces 47 with sufficient space in the directions orthogonal to the direction of the insertion of the insertion plate 14. On the other hand, if the inclination of the guide surfaces 47 exceeds 60 degrees, the slide friction between the insertion plate 14 and the guide surfaces 54 may increase to the point where the operator experiences excessive resistance to the plate insertion. For this reason, too steep an inclination diminishes the effect of enlarging the area of the openings 46 of the edge insertion holes 42 by the guide surfaces 47. In light of the above, the inclination a of each guide surface 47 with respect to the central axis of the respective edge insertion hole 42 is preferably set between 30 degrees and 40 degrees.

Having described a preferred embodiment of the present invention, it should be understood that the present invention is not limited to the specific description of the embodiment. Although each guide surface 47 of the foregoing embodiment is configured in a conical shape expanding around the associated opening 46, any configuration will suffice as long as the guide surface extends obliquely outward from the opening 46. For example, an alternate guide surface 47 may include numerous tapered surfaces connected circumferentially via inflections.

Furthermore, the guide surfaces 47 serve their intended purpose as long as these surfaces surround and extend from their respective openings 46 of the edge insertion holes 42 outward of their respective edge insertion holes 42 in the direction along which the edge insertion holes 42 oppose each other and in the upward and downward directions orthogonal to the opposing direction. As such, each guide surface 47 may be comprised only of the first split guide surfaces 48a and 48b.

What is claimed is:

1. An electrical connection box comprising a bracket insertion member (18) having an insertion hole (16) into which an insertion plate (14) of a fixing bracket (12) provided on an automobile is inserted,
the insertion hole (16) including edge insertion holes (42) into which edge portions (34) of the insertion plate (14) of the fixing bracket (12) are inserted,
a guide surface (47) being formed on an opening of each edge insertion hole (42), the guide surface (47) extending obliquely out from the opening in directions opposite to the direction of insertion of the insertion plate (14) into the insertion hole (14),
each guide surface (47) extending out in a direction along which the edge insertion holes (42) oppose each other and in directions orthogonal to the direction along which the edge insertion holes (42) oppose each other, and
in a planar view of the bracket insertion member (18), a dimension between an outer edge of each opening and an outer edge of the associated guide surface is no less than a thickness of the insertion plate (14).

2. The electrical connection box of claim 1, wherein each guide surface (47) extends in a generally conical shape around the opening of the associated edge insertion hole (42).

3. The electrical connection box of claim 2, wherein a finger-engaging portion (56) is formed on a rear side of each guide surface (47) along outer peripheries of the bracket insertion member (18), the finger-engaging portion (56) widening towards the opening of the edge insertion hole (42) from an intermediate point along the depth of the edge insertion hole (42).

4. The electrical connection box of claim 2, wherein each guide surface is inclined with respect to a central axis of the edge insertion hole (42) at an angle of between 30 degrees and 60 degrees.
